(19) United States
(12) Patent Application Publication
(10) Pub. No.: US 2022/0153410 A1
(43) Pub. Date: May 19, 2022

(54) Unmanned Aerial Vehicle Assembly

(71) Applicant: Michael Stewart, Irvington, NJ (US)

(72) Inventor: Michael Stewart, Irvington, NJ (US)

(21) Appl. No.: 17/098,546

(22) Filed: Nov. 16, 2020

(51) Int. Cl. B64C 39/02; B64C 25/32; B64D 47/08; B64D 43/00; B64D 27/24; G05D 1/00; H04N 5/247; H04R 1/08; G06F 3/041; G06F 3/0488; G08C 17/02; H04L 29/08

(52) U.S. Cl. CPC B64C 39/024; H04R 2499/13; B64D 47/08; B64D 43/00; B64D 27/24; G05D 1/0016; H04N 5/247; H04R 1/08; G06F 3/041; G06F 3/04883; G08C 17/02; H04L 67/12; B64C 2201/027; B64C 2201/042; B64C 2201/127; B64C 2201/146; B64C 25/32

(57) ABSTRACT

An unmanned aerial vehicle assembly includes an unmanned aerial vehicle including a plurality of propulsion units thereby facilitating the unmanned aerial vehicle to fly. A plurality of cameras is each coupled to the unmanned aerial vehicle to capture imagery of the area surrounding the unmanned aerial vehicle. A microphone is coupled to the unmanned aerial vehicle to capture audible sounds in the area surrounding the unmanned aerial vehicle. A transceiver is integrated into the unmanned aerial vehicle and the transceiver is in communication with an extrinsic communication network. In this way the transceiver can receive flight control commands from a personal electronic device that is in communication with the extrinsic communication network thereby facilitating an authorized user to remotely control the unmanned aerial vehicle. A user interface is integrated into the unmanned aerial vehicle to capture a signature from a person. The user interface is in electrical communication with the transceiver thereby facilitating the signature to be communicated to the authorized user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to aerial vehicle devices and more particularly pertains to a new aerial vehicle device for monitoring a large area and for capturing a signature from a person.

### (2) Description of Related Art Including Information Disclosed Under 37 CFR 1.97 and 1.98

The prior art relates to aerial vehicle devices including an unmanned aerial device (unmanned aerial vehicle) that is self guided for navigating an enclosed area. The prior art discloses a variety of monitoring systems that each at least includes an unmanned aerial vehicle and a remote computer database that receives wireless data from the unmanned aerial vehicle.

### BRIEF SUMMARY OF THE INVENTION

An embodiment of the disclosure meets the needs presented above by generally comprising an unmanned aerial vehicle including a plurality of propulsion units thereby facilitating the unmanned aerial vehicle to fly. A plurality of cameras is each coupled to the unmanned aerial vehicle to capture imagery of the area surrounding the unmanned aerial vehicle. A microphone is coupled to the unmanned aerial vehicle to capture audible sounds in the area surrounding the unmanned aerial vehicle. A transceiver is integrated into the unmanned aerial vehicle and the transceiver is in communication with an extrinsic communication network. In this way the transceiver can receive flight control commands from a personal electronic device that is in communication with the extrinsic communication network thereby facilitating an authorized user to remotely control the unmanned aerial vehicle. A user interface is integrated into the unmanned aerial vehicle to capture a signature from a person. The user interface is in electrical communication with the transceiver thereby facilitating the signature to be communicated to the authorized user.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an unmanned aerial vehicle assembly according to an embodiment of the disclosure.

FIG. 2 is a back view of an embodiment of the disclosure.

FIG. 3 is a top view of an embodiment of the disclosure.

FIG. 4 is a bottom view of an embodiment of the disclosure.

FIG. 5 is a left side view of an embodiment of the disclosure.

FIG. 6 is a perspective in-use view of an embodiment of the disclosure.

FIG. 7 is a schematic view of an embodiment of the disclosure.

### DETAILED DESCRIPTION OF THE INVENTION

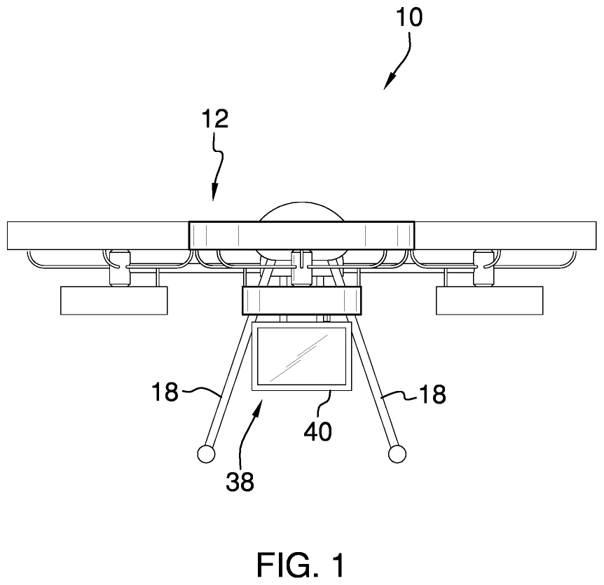

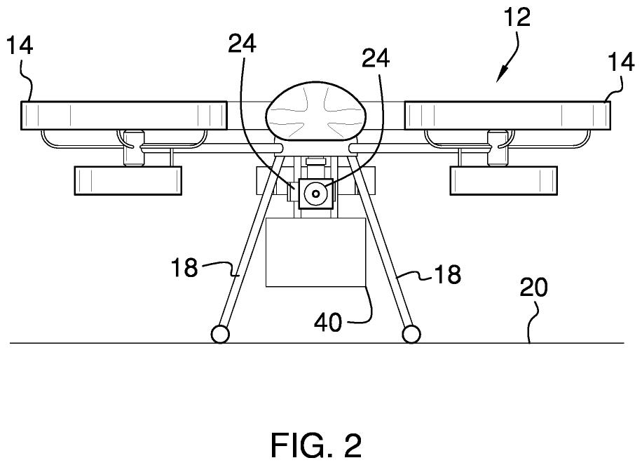

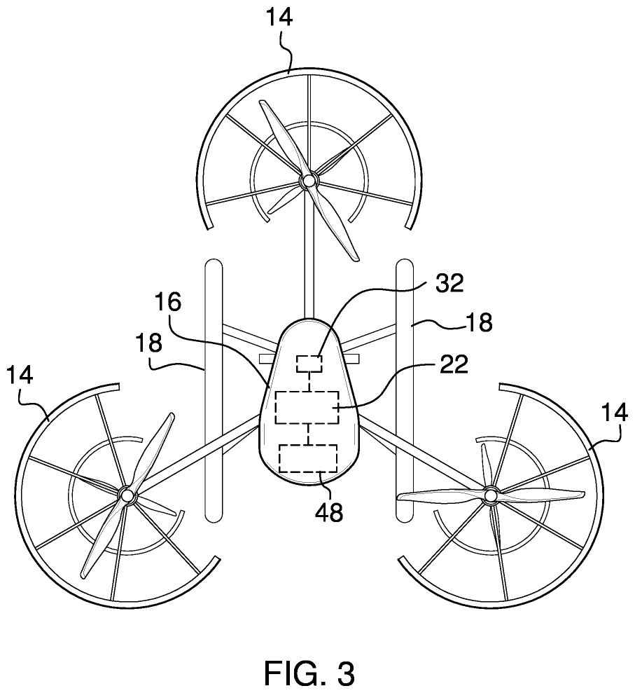

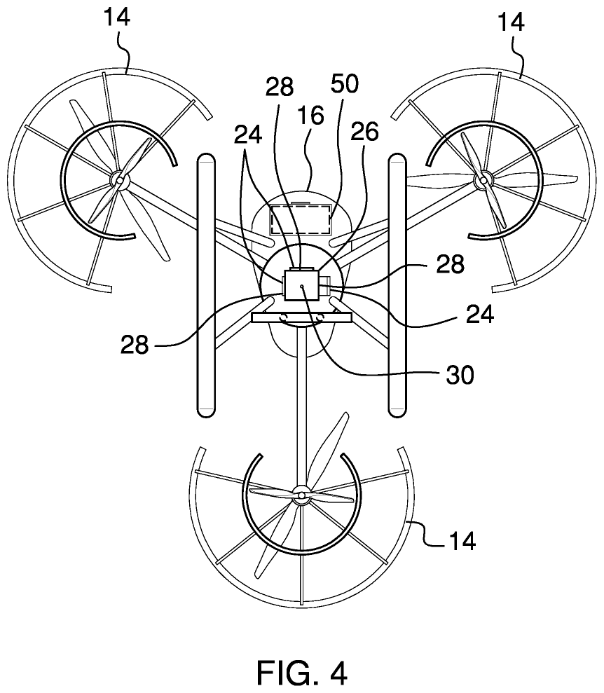

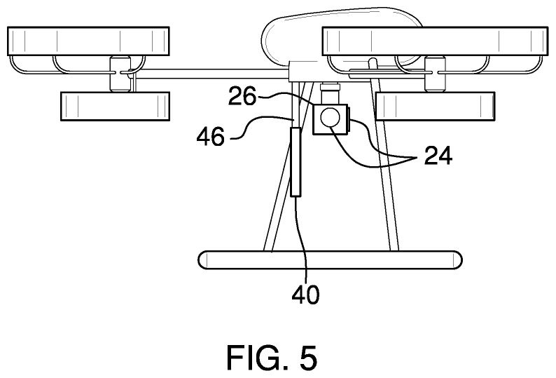

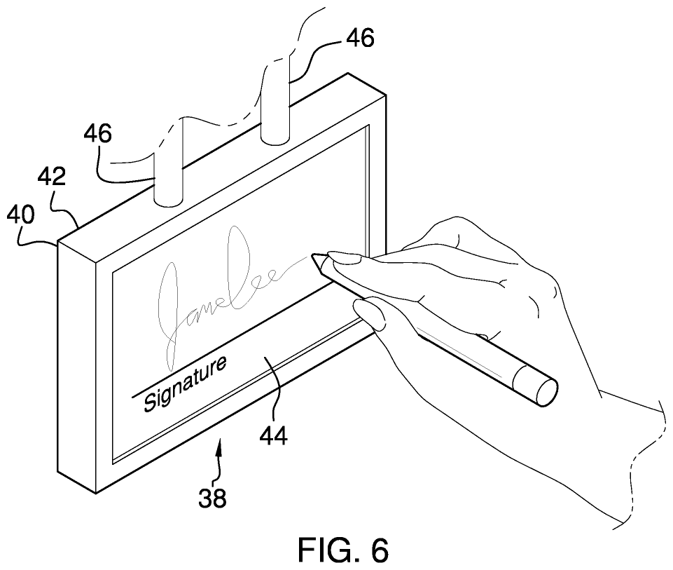

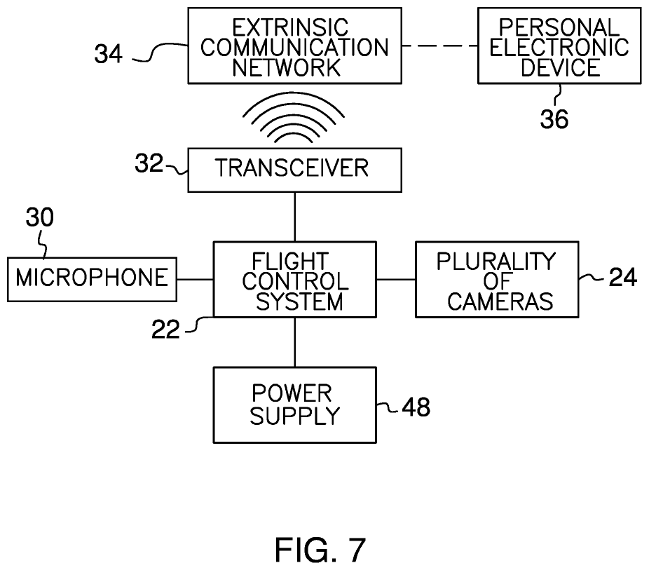

With reference now to the drawings, and in particular to FIGS. 1 through 7 thereof, a new aerial vehicle device embodying the principles and concepts of an embodiment of the disclosure and generally designated by the reference numeral 10 will be described.

As best illustrated in FIGS. 1 through 7, the unmanned aerial vehicle assembly 10 generally comprises an unmanned aerial vehicle 12 which includes a plurality of propulsion units 14 thereby facilitating the unmanned aerial vehicle 12 to fly. The propulsion units 14 may include an electric motor and a propeller or any other propulsion unit that is commonly employed on existing unmanned aerial vehicles. The unmanned aerial vehicle 12 includes a fuselage 16 and a plurality of legs 18 each extending downwardly from the fuselage 16 to support the fuselage 16 above a support surface 20 when the unmanned aerial vehicle 12 lands. A flight control system 22 is integrated into the unmanned aerial vehicle 12 and the flight control system 22 is in electrical communication with each of the propulsion units 14 thereby facilitating flight characteristics of the unmanned aerial vehicle 12 to be controlled. The flight control system 22 may include components that are common to existing unmanned aerial vehicle flight control systems.

A plurality of cameras 24 is included and each of the cameras 24 is coupled to the unmanned aerial vehicle 12 to capture imagery of the area surrounding the unmanned aerial vehicle 12. Additionally, each of the cameras 24 is electrically coupled to the flight control system 22. A housing 26 may be coupled to and extend downwardly from the fuselage 16 and the housing 26 may have a plurality of intersecting lateral faces 28. Each of the cameras 24 may be positioned on a respective intersecting lateral face 28 such that the cameras 24 facilitate 360.0 degrees of imagery with respect to the unmanned aerial vehicle 12. Additionally, each of the cameras 24 may comprise a digital video camera or the like. A microphone 30 is coupled to the unmanned aerial vehicle 12 to capture audible sounds in the area surrounding the unmanned aerial vehicle 12. The microphone 30 is electrically coupled to the flight control system 22 and the microphone 30 may be positioned on the housing 26 to which the cameras 24 are mounted.

A transceiver 32 is integrated into the unmanned aerial vehicle 12 and the transceiver 32 is in communication with an extrinsic communication network 34. Moreover, the transceiver 32 can receive flight control commands from a personal electronic device 36 that is in communication with the extrinsic communication network 34. In this way a user can to remotely control the unmanned aerial vehicle 12 with specialized software that is stored on the personal electronic device 36, such as a smart phone app that is stored in a smart phone. The transceiver 32 is electrically coupled to the flight control system 22, the transceiver 32 may comprise a radio frequency transceiver or the like and the transceiver 32 may employ a WPAN signal. Additionally, the extrinsic communication network 34 may be a cellular phone network, the internet or any other wireless communication network.

A user interface 38 is provided and the user interface 38 is integrated into the unmanned aerial vehicle 12 to capture a signature from a person. The user interface 38 is in electrical communication with the transceiver 32 thereby facilitating the signature to be communicated to the authorized user. The user interface 38 comprises a touch screen 40 that is suspended from the unmanned aerial vehicle 12 to capture the signature of the person. The touch screen 40 is electrically coupled to the flight control system 22 thereby facilitating the transceiver 32 to communicate the signature to the extrinsic communication network 34 for authorizing a transaction to occur with respect to the person from whom the signature is captured. The touch screen 40 may comprise an LED touch screen or other type of electronic touch screen, and the touch screen 40 has a top edge 42 and a forward side 44.

A pair of supports 46 is each coupled between the fuselage 16 and the top edge 42 of the touch screen 40 such that the touch screen 40 is suspended beneath the fuselage 16. In this way the forward side 44 of the touch screen 40 is accessible to the person for capturing the person's signature. A power supply 48 is removably positioned in the unmanned aerial vehicle 12, the power supply 48 is electrically coupled to the flight control system 22 and the power supply 48 comprises at least one battery. A battery cover 50 is removably coupled to the fuselage 16 and the power supply 48 is positioned behind the battery cover 50.

In use, the unmanned aerial vehicle 12 is employed to monitor a large area, such as a commercial construction site, a mining site or other large area. Additionally, the transceiver 32 facilitates the unmanned aerial vehicle 12 to be controlled by a user that is located a great distance away from the unmanned aerial vehicle 12 by facilitating the user to employ a smart phone to remotely control the unmanned aerial vehicle 12. The footage from the cameras 24 may be constantly broadcast to a remote storage device for subsequent analysis. Additionally, the touch screen 40 can capture a signature from a person in the area such as approving changes to construction plans, authorizing a purchase or any other type of remote transaction.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An unmanned aerial vehicle assembly for remotely surveying a predetermined location, said assembly comprising:
an unmanned aerial vehicle including a plurality of propulsion units thereby facilitating said unmanned aerial vehicle to fly, said unmanned aerial vehicle including a fuselage and a plurality of legs each extending downwardly from said fuselage wherein said plurality of legs is configured to support said fuselage above a support surface when said unmanned aerial vehicle lands;
a flight control system being integrated into said unmanned aerial vehicle, said flight control system being in electrical communication with each of said propulsion units thereby facilitating flight characteristics of said unmanned aerial vehicle to be controlled;
a plurality of cameras, each of said cameras being coupled to said unmanned aerial vehicle wherein said plurality of cameras is configured to capture imagery of the area surrounding said unmanned aerial vehicle, each of said cameras being electrically coupled to said flight control system;
a microphone being coupled to said unmanned aerial vehicle wherein said microphone is configured to capture audible sounds in the area surrounding said unmanned aerial vehicle, said microphone being electrically coupled to said flight control system;
a transceiver being integrated into said unmanned aerial vehicle, said transceiver being in communication with an extrinsic communication network wherein said transceiver is configured to receive flight control commands from a personal electronic device that is in communication with the extrinsic communication network thereby facilitating an authorized user to remotely control said unmanned aerial vehicle, said transceiver being electrically coupled to said flight control system; and
a user interface being integrated into said unmanned aerial vehicle wherein said user interface is configured to capture a signature from a person, said user interface being in electrical communication with said transceiver thereby facilitating the signature to be communicated to the authorized user.

2. The assembly according to claim 1, wherein said user interface comprises a touch screen being suspended from said unmanned aerial vehicle wherein said touch screen is configured to capture a signature of a person, said touch screen being electrically coupled to said flight control system wherein said transceiver is configured to communicate the signature to the extrinsic communication network for authorizing a transaction to occur with respect to the person from whom the signature is captured.

3. An unmanned aerial vehicle assembly for remotely surveying a predetermined location, said assembly comprising:
an unmanned aerial vehicle including a plurality of propulsion units thereby facilitating said unmanned aerial vehicle to fly, said unmanned aerial vehicle including a fuselage and a plurality of legs each extending downwardly from said fuselage wherein said plurality of legs is configured to support said fuselage above a support surface when said unmanned aerial vehicle lands;
a flight control system being integrated into said unmanned aerial vehicle, said flight control system being in electrical communication with each of said propulsion units thereby facilitating flight characteristics of said unmanned aerial vehicle to be controlled;
a plurality of cameras, each of said cameras being coupled to said unmanned aerial vehicle wherein said plurality of cameras is configured to capture imagery of the area surrounding said unmanned aerial vehicle, each of said cameras being electrically coupled to said flight control system;
a microphone being coupled to said unmanned aerial vehicle wherein said microphone is configured to capture audible sounds in the area surrounding said unmanned aerial vehicle, said microphone being electrically coupled to said flight control system;
a transceiver being integrated into said unmanned aerial vehicle, said transceiver being in communication with an extrinsic communication network wherein said transceiver is configured to receive flight control commands from a personal electronic device that is in communication with the extrinsic communication network thereby facilitating an authorized user to remotely control said unmanned aerial vehicle, said transceiver being electrically coupled to said flight control system; and
a touch screen being suspended from said unmanned aerial vehicle wherein said touch screen is configured to capture a signature of a person, said touch screen being electrically coupled to said flight control system wherein said transceiver is configured to communicate the signature to the extrinsic communication network for authorizing a transaction to occur with respect to the person from whom the signature is captured.

4. The assembly according to claim 3, wherein:
said touch screen has a top edge and a forward side; and
a pair of supports, each of said supports being coupled between said fuselage and said top edge of said touch screen such that said touch screen is suspended beneath said fuselage wherein said forward side is configured to be accessible to the person for capturing the person's signature.

5. An unmanned aerial vehicle assembly for remotely surveying a predetermined location, said assembly comprising:
an unmanned aerial vehicle including a plurality of propulsion units thereby facilitating said unmanned aerial vehicle to fly, said unmanned aerial vehicle including a fuselage and a plurality of legs each extending downwardly from said fuselage wherein said plurality of legs is configured to support said fuselage above a support surface when said unmanned aerial vehicle lands;
a flight control system being integrated into said unmanned aerial vehicle, said flight control system being in electrical communication with each of said propulsion units thereby facilitating flight characteristics of said unmanned aerial vehicle to be controlled;
a plurality of cameras, each of said cameras being coupled to said unmanned aerial vehicle wherein said plurality of cameras is configured to capture imagery of the area surrounding said unmanned aerial vehicle, each of said cameras being electrically coupled to said flight control system;
a microphone being coupled to said unmanned aerial vehicle wherein said microphone is configured to capture audible sounds in the area surrounding said unmanned aerial vehicle, said microphone being electrically coupled to said flight control system;
a transceiver being integrated into said unmanned aerial vehicle, said transceiver being in communication with an extrinsic communication network wherein said transceiver is configured to receive flight control commands from a personal electronic device that is in communication with the extrinsic communication network thereby facilitating a user to remotely control said unmanned aerial vehicle, said transceiver being electrically coupled to said flight control system;
a user interface being integrated into said unmanned aerial vehicle wherein said user interface is configured to capture a signature from a person, said user interface being in electrical communication with said transceiver thereby facilitating the signature to be communicated to the authorized user, said user interface comprising:
a touch screen being suspended from said unmanned aerial vehicle wherein said touch screen is configured to capture a signature of a person, said touch screen being electrically coupled to said flight control system wherein said transceiver is configured to communicate the signature to the extrinsic communication network for authorizing a transaction to occur with respect to the person from whom the signature is captured, said touch screen having a top edge and a forward side; and
a pair of supports, each of said supports being coupled between said fuselage and said top edge of said touch screen such that said touch screen is suspended beneath said fuselage wherein said forward side is configured to be accessible to the person for capturing the person's signature; and
a power supply being removably positioned in said unmanned aerial vehicle, said power supply being electrically coupled to said flight control system, said power supply comprising at least one battery.
